(19) United States
(12) Patent Application Publication
(10) Pub. No.: US 2025/0215884 A1
(43) Pub. Date: Jul. 3, 2025

(54) METHOD FOR OPERATING A POWER GENERATION DEVICE HAVING A CHARGE AIR COMPRESSOR, CONTROL DEVICE FOR CARRYING OUT SUCH A METHOD, AND POWER GENERATION DEVICE HAVING SUCH A CONTROL DEVICE

(71) Applicant: Rolls-Royce Solutions GmbH, Friedrichshafen (DE)

(72) Inventors: Tobias Schmid, Friedrichshafen (DE); Moritz Röthlingshöfer, Immenstaad (DE); Erika Schäfer, Friedrichshafen (DE)

(73) Assignee: Rolls-Royce Solutions GmbH, Friedrichshafen (DE)

(21) Appl. No.: 19/048,026

(22) Filed: Feb. 7, 2025

Related U.S. Application Data
(63) Continuation of application No. PCT/EP2023/071326, filed on Aug. 1, 2023.

(30) Foreign Application Priority Data
Aug. 8, 2022 (DE) 10 2022 119 944.4
Aug. 1, 2023 (WO) PCT/EP2023/071326

(51) Int. Cl. F04D 27/00; F02B 37/12

(52) U.S. Cl. CPC F04D 27/001; F02B 37/12

(57) ABSTRACT

A method for operating a power generation device, including the steps of: providing that the power generation device includes a charge air compressor; detecting a charge air pressure downstream of the charge air compressor, and checking the charge air pressure downstream of the charge air compressor for a pressure drop; detecting an additional operating parameter of the power generation device which is correlated with the charge air pressure; evaluating the additional operating parameter in regard to a plausibility of a surge event having caused the pressure drop in the charge air pressure; and identifying the surge event of the charge air compressor if a drop in the charge air pressure—which is detected—is identified, and, based on the step of evaluating the additional operating parameter, the surge event is evaluated to be plausible for having caused the pressure drop in the charge air pressure.

### CROSS REFERENCE TO RELATED APPLICATIONS

This is a continuation of International patent application no. PCT/EP2023/071326, entitled “METHOD FOR OPERATING A POWER GENERATION DEVICE HAVING A CHARGE AIR COMPRESSOR, CONTROL DEVICE FOR CARRYING OUT SUCH A METHOD, AND POWER GENERATION DEVICE HAVING SUCH A CONTROL DEVICE”, filed Aug. 1, 2023, which is incorporated herein by reference. International patent application no. PCT/EP2023/071326 claims priority to German patent application no. 10 2022 119 944.4, filed Aug. 8, 2022, which is incorporated herein by reference.

### BACKGROUND OF THE INVENTION

### 1. Field of the Invention

The present invention relates to power generation devices.

### 2. Description of the Related Art

During operation of a charge air compressor, various influences can lead to stalling of the compressor impeller blades, which is also referred to as compressor surging or simply surging. This leads to critical conditions for a power generation device that has the charge air compressor, for example a drop in charge air pressure, noise creation, heating of a charge path, and possibly to the point of flame formation in critical components such as an air filter. Furthermore, the compressor impeller and the structures surrounding it, such as stationary guide vanes, suffer greatly from surging, which shortens the service life of the charge air compressor. The compressor impeller may even be destroyed, which can lead to further problems and, in particular, significant danger for people in the vicinity. Since it seems almost impossible to completely rule out the occurrence of surging, it seems all the more important to be able to reliably identify such conditions. This has however turned out to be difficult, as failing to identify surge events that actually occur (false negative result), as well as incorrectly concluding that a surge event has occurred when no compressor surging is occurring (false positive result) are both detrimental. In the first case, the charge air compressor suffers, and the already described problems occur; in the second case, it is possible that the power generation device is operated sub-optimally due to an incorrectly identified compressor surging, which has a negative effect on its efficiency and possibly on emissions.

What is needed in the art is a method for operating a power generation device having a charge air compressor, a control device for carrying out such a method and a power generation device with such a control device, wherein the aforementioned disadvantages are at least reduced, optionally prevented.

### SUMMARY OF THE INVENTION

The invention relates to a method for operating a power generation device having a charge air compressor, control device for carrying out such a method, and power generation device having such a control device.

The present invention provides a method for operating a power generation device having a charge air compressor. A charge air pressure downstream of the charge air compressor is detected, in particular continuously, and is checked for a pressure drop. In addition, at least one additional operating parameter of the power generation device that is correlated with the charge air pressure is detected, in particular continuously. The at least one additional operating parameter is evaluated—in particular continuously—in regard to plausibility of a surge event as the cause of a pressure drop in the charge air pressure; and a surge event of the charge air compressor is identified if a drop in the detected charge air pressure is identified and, based on the evaluation of the at least one additional operating parameter, a surge event is assessed as being plausible as the cause of the pressure drop in the charge air pressure, in other words, is recognized as a plausible cause of the pressure drop in the charge air pressure. Advantageously, compressor surging can be identified very reliably in this manner so that both the number of false-positive and false-negative results can at least be reduced, whereby incorrect results and assignments of events optionally are completely avoided. In this respect, it has been recognized that the pressure drop in the charge air pressure in itself is not always a sufficient criterion for a reliable diagnosis of compressor surging. However, by additionally detecting and evaluating at least one additional operating parameter that is correlated with the charge air pressure, the reliability of identification can be significantly increased. This in turn allows suitable targeted measures to be taken to at least reduce the adverse effects of surge events.

In one embodiment, the charge air pressure downstream of the charge air compressor is continuously detected during operation of the power generating device and monitored for a pressure drop.

In one embodiment, it is possible that recognition of a pressure drop initiates or triggers the subsequent process steps, wherein in this embodiment in particular the at least one additional operating parameter is only detected and evaluated if a pressure drop in the charge air pressure is previously identified.

In another embodiment, the at least one additional operating parameter is also continuously detected and in particular continuously evaluated. Recording of the at least one additional operating parameter and in particular its evaluation therefore occurs regardless of whether a pressure drop is identified. In order to conclude that a surge event has occurred, however, the condition of the pressure drop on the one hand and the evaluation of the at least one additional operating parameter on the other hand are jointly considered, in particular linked to one another by a logic AND.

In one embodiment, a pressure drop in the charge air pressure is identified when a second time derivative of the charge air pressure falls below a predetermined negative derivative limit value. This represents a particularly reliable criterion for identifying a pressure drop that is particularly relevant with regard to a surge event.

In particular, a surge event of the charge air compressor is identified every time a drop in the recorded charge air pressure is detected and if, in addition, the evaluation of the at least one additional operating parameter returns a surge event as a plausible cause for the pressure drop in the charge air pressure.

In one embodiment, based on evaluation of the at least one additional operating parameter, a surge event is assessed as plausible as the cause of the pressure drop if no other cause for the pressure drop in the charge air pressure has been identified by the evaluation. In this arrangement, a surge event of the charge air compressor is identified if a drop in the detected charge air pressure is identified and evaluation of the at least one additional operating parameter does not return any other cause for the pressure drop in the charge air pressure. Thus, identification occurs in particular by excluding other possible causes.

Alternatively, or in addition, a surge event is assessed as plausible as the cause of the pressure drop based on the evaluation of the at least one additional operating parameter, if the evaluation establishes at least one specific temporal progression or a specific behavior of the at least one additional operating parameter, wherein the specific temporal progression or the specific behavior of the at least one additional operating parameter in particular suggests a surge event or is characteristic of a surge event. A positive identification of a surge event occurs in particular in this case.

A further development of the present invention provides that a key figure is determined which indicates how many surge events are identified within a predetermined time window, wherein at least a first measure is initiated if the key figure determined exceeds a predetermined first key figure limit value. This advantageously makes it possible to implement targeted measures to reduce the effects of surge events occurring at a higher temporal frequency.

The key figure is recorded continuously during operation of the power generation device. In one embodiment, the key figure is recorded for the predetermined time window, then for a subsequent predetermined time window, and so on, in other words, from time window to time window. The key figure is thereby incremented in particular within a time window and reset at the end of the time window, in particular set to zero. In another embodiment, the key figure is determined as a sliding value. It is possible for the key figure to be incremented when a surge event occurs, the time at which the sure event occurred being noted; the key figure is again decremented at an interval of a predetermined time window from the surge event. In this arrangement the key figure indicates the number of surge events at any current point in time in a period that extends into the past, originating from the current point in time by subtracting the predetermined time window.

During operation of the power generation device the determined key figure is continuously compared with the predetermined first key figure limit value. This means that the first measure can be initiated quickly and in a targeted manner.

In particular, no action will be taken if the determined key figure does not exceed the predetermined first key figure limit value.

A further development of the present invention provides that at least a second measure is initiated when the determined key figure exceeds a predetermined second key figure limit value, wherein the predetermined second key figure limit value is greater than the predetermined first key figure limit value. Thus, one can advantageously differentiate between cases of surge events of varying severity, wherein depending on the frequency with which the surge events occur, different measures—in particular different strong or serious measures—can be taken in order to mitigate or avert negative consequences of compressor surging to the extent possible.

In particular, the determined key figure is continuously compared with the predetermined second key figure limit value during operation of the power generation device. The second measure can thus be initiated quickly and in a targeted manner.

A further development of the present invention provides that it is checked as to whether the power generating device is operated within a predetermined operating range, wherein a surge event only identified—in particular in addition to the other aforementioned criteria—if the power generating device is operated within the predetermined operating range. This can advantageously save resources, in particular computing power, in that identification of a surge event does not occur if the power generation device is operating outside the predetermined operating range and thus in particular in an operating range in which the occurrence of compressor surges is impossible or at least unlikely. At the same time, this also increases the accuracy of the identification by expressly excluding such operating ranges for the identification of surge events.

In particular, no surge event is identified if the power generating device is not operated within the predetermined operating range.

The predetermined operating range is defined in particular in a characteristic map, in particular as a predetermined characteristic map range. The characteristic map is in particular spread by a rotational speed and a torque of the power generating device. Alternatively, the characteristic map is spread by an electrical voltage and an electrical current of the power generating device.

A further development of the present invention provides that it is checked as to whether a transient operating state exists for the power generation device, with a surge event only being identified if—in particular in addition to the other aforementioned criteria—no transient operating state exists for the power generation device. This is based on the idea that compressor surging cannot be reliably identified in a transient operating range, in particular in the event of a drop in power or load shedding. By excluding transient operating states for identification of surge events, the accuracy of the identification is advantageously further increased.

In particular, no surge event is identified in the case of transient operation for the power generating device.

A further development of the present invention provides that the at least one first measure is selected from a group consisting of a first alarm, a change in a flow cross-section of a compressor bypass path around the charge air compressor, and a change in a flow cross-section of a charge path in which the charge air compressor is arranged.

In the context of the present technical teaching, a first alarm is understood to mean in particular a first, in particular less urgent, warning to an operator of the power generation device, in particular a yellow alarm, in particular a request for inspection. The first warning can be issued acoustically, optically, haptically or in any other suitable manner, as well as in combinations of the aforementioned methods.

The flow cross-section in the compressor bypass path is changed in particular by changing a flap position or valve setting of a bypass path adjusting device in the compressor bypass path. The compressor bypass path is in particular a compressor bypass. In particular, a bypass path adjusting device, in particular a bypass valve or a bypass flap, is arranged in the compressor bypass, via which the flow cross-section of the compressor bypass path can be changed.

The flow cross-section in the charge path is changed in particular by changing a flap position or valve position of a charge path adjusting device in the charge path. The charge path is in particular an air path or charge air path of the power generation device, in which the charge air compressor is arranged. In particular, a charge path adjusting device, in particular a throttle valve or a throttle flap, is arranged in the charge path, via which the flow cross-section of the charge path can be changed.

A further development of the present invention provides that the at least one second measure is selected from a group consisting of a second alarm and a shutdown of the power generation device. The measures to be taken can thus advantageously be escalated depending on the frequency of the occurrence of surge events, wherein the higher escalation level, in particular a shutdown of the power generation device, is only reached if the surge events occur with the predetermined, greater frequency.

In the context of the present technical teaching, a second alarm is understood to mean in particular a second, in particular more urgent, warning, in particular a request to an operator of the power generation device to take action, in particular a red alarm. The second warning can be issued acoustically, optically, haptically or in any other suitable manner, as well as in combinations of the aforementioned methods.

A further development of the present invention provides that a compressor of an exhaust gas turbocharger of the power generation device is operated as the charge air compressor, wherein an operating parameter that is correlated—in particular positively—with an exhaust gas mass flow of the power generation device is used as the at least one additional operating parameter.

In addition to the pressure drop in the charge path, the exhaust gas mass flow via a turbine that is drive-connected to the charge air compressor is a highly suitable criterion for being able to accurately identify compressor surging. This is advantageously exploited by evaluating the operating parameter that is correlated—in particular positively—with the exhaust gas mass flow.

In particular, an operating parameter is used as the at least one additional operating parameter which is functionally linked to the exhaust gas mass flow of the power generation device, either such that the exhaust gas mass flow depends on the operating parameter, or such that the operating parameter depends on the exhaust gas mass flow. In one embodiment, an operating parameter is used as the at least one additional operating parameter whose value increases when the exhaust gas mass flow increases and whose value decreases when the exhaust gas mass flow decreases. In particular, the value of the operating parameter remains the same when the exhaust gas mass flow remains the same.

A further development of the present invention provides that a torque of the power generation device is detected as the at least one additional operating parameter, in particular when the power generation device is designed as an internal combustion engine. The torque of the power generation device represents a particularly suitable additional operating parameter in order to be able to identify the presence of a compressor surge. In particular, the torque is correlated—in particular positively—with the exhaust gas mass flow via the turbine of the exhaust gas turbocharger. In one embodiment, the torque is measured at the power generation device. In another embodiment, the torque is calculated in particular from operating data of the power generation device, in particular in a control device. The torque can be calculated, in particular based on injection data of the power generation device, in particular a fuel pressure and an opening duration of an injector.

Alternatively, it is possible that an output power of the power generation device and/or an electrical current output by the power generation device is detected as the at least one additional operating parameter, in particular if the power generation device is designed as a fuel cell. In this case, the output power or the output electrical current is correlated—in particular positively—with an exhaust gas mass flow of the fuel cell.

In particular, it is checked whether the at least one additional operating parameter, in particular the torque, the output power or the output electrical current, drops. In particular, based on the evaluation of the at least one additional operating parameter, a surge event is assessed as plausible as the cause of the pressure drop in the charge air pressure if it is determined that the at least one additional operating parameter does not drop. In particular, in this case there is no drop in power or torque, which would otherwise explain the pressure drop in the charge air pressure even without a surge event. Therefore, there is notably no other cause for the pressure drop than a surge event, so that a surge event can be concluded with a high degree of certainty.

Additionally, or alternatively, it is checked whether the at least additional other operating parameter, in particular the torque, the output power or the output electrical current, is increasing. In particular, if the at least one additional operating parameter is increasing, a cause for the pressure drop other than a surge event can be almost certainly ruled out. In particular, in such a case, in the absence of compressor surging, an increase in the charge air pressure must actually be expected. If the charge air pressure therefore drops in such a situation, it is almost certain that a surge event has occurred.

In one embodiment, the evaluation of the at least one additional operating parameter is implicitly included in the check for transient operation. This means in particular that a surge event is assessed as plausible as the cause of the pressure drop if no transient operation is detected. If, on the other hand, transient operation is detected for the power generation device, it is assumed that no surge event is present, since the transient operation is considered a possible cause of the pressure drop.

The present invention also provides a control device for a power generation device, which is set up to conduct a method according to the present invention or a method according to one or a number of the previously described embodiments. In connection with the control device, advantages result in particular, that have already been explained above in connection with the method.

The present invention also provides a power generation device that has a charge path in which a charge air compressor is arranged. The power generation device also has a control device according to the present invention or a control device according to one or a number of the previously described embodiments. In connection with the power generation device, the advantages result in particular that have already been explained above in connection with the method or the control device.

The control device is in particular operatively connected to a charge air pressure sensor arranged in the charge path downstream of the charge air compressor.

The control device is designed in particular to detect and evaluate the at least one additional operating parameter. In one embodiment, the control device is operatively connected to at least one operating parameter sensor in order to detect the at least one additional operating parameter. Alternatively, or in addition, the control device is designed to calculate the at least one additional operating parameter.

A further development of the invention provides that the charge air compressor is drive-connected to a turbine arranged in an exhaust gas path of the power generation device. In particular, the charge air compressor is designed as a compressor of an exhaust gas turbocharger of the power generation device.

A further development of the present invention provides that the power generation device is designed as an internal combustion engine. Alternatively, the power generation device is designed as a fuel cell.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a power generation device with a design example of a control device;

FIG. 2 is a first schematic representation of an embodiment of a method for operating a power generation device according to FIG. 1; and

FIG. 3 is a second schematic representation of an embodiment of the method.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

FIG. 1 shows a schematic representation of a design example of a power generation device 1 with a design example of a control device 3.

Power generation device 1 has a charge path 5 in which a charge air compressor 7 is arranged. Charge air compressor 7 is in particular part of an exhaust gas turbocharger 9 of power generation device 1 and is drive-connected to a turbine 13 arranged in an exhaust gas path 11 of power generation device 1.

Power generation device 1 in the herein shown design example is designed in particular as an internal combustion engine and has an engine block 15. In another design example which is not shown, it is possible for power generation device 1 to be designed as a fuel cell.

Control device 3 is operatively connected to a first charge air pressure sensor 17 arranged in charge path 5 downstream of charge air compressor 7 in order to be able to detect the charge air pressure in charge path 5 downstream of charge air compressor 7. In the design example shown here, control device 3 is additionally operatively connected to a second charge air pressure sensor 19 arranged in charge path 5 upstream of charge air compressor 7 in order to be able to detect the charge air pressure in charge path 5 also upstream of charge air compressor 7. This can advantageously contribute in particular to a higher accuracy or plausibility of identification of a pressure drop in the charge air pressure downstream of charge air compressor 7.

In the design example shown herein, control device 3 is also designed to detect and evaluate at least one additional operating parameter of power generation device 1, in particular of the internal combustion engine and especially of engine block 15. For this purpose, control device 3 is operatively connected to an operating parameter sensor 21. Alternatively, or in addition, it is possible that control device 3 is designed to calculate the at least one additional operating parameter, in particular based on additional parameters detected on power generation device 1 and in particular on engine block 15.

An operating parameter is optionally used as the at least one additional operating parameter, which is positively correlated with an exhaust gas mass flow in exhaust gas path 11 of power generation device 1. Optionally, as the at least one further operating parameter, a torque of the power generation device 1 is detected, in particular measured or calculated, wherein it is checked in particular whether the torque drops or increases, and wherein in particular a surge event is assessed as plausible as the cause of the pressure drop in the charge air pressure if it is determined that the torque does not drop or if it is determined that the torque increases.

In the design example shown here, control device 3 is also designed to change a flow cross-section in a compressor bypass path 23. For this purpose, it is in particular operatively connected with bypass flap 25 in order to change the flap position of bypass flap 25 as a bypass path adjusting device in compressor bypass path 23.

Alternatively, or in addition, it is possible—in a manner not explicitly shown here—that control device 3 is designed to change a flow cross-section in charge path 5, in particular by changing a flap position or valve setting of a charge path regulating device (not shown) in charge path 5.

Control device 3 is designed, in particular to conduct a method described below.

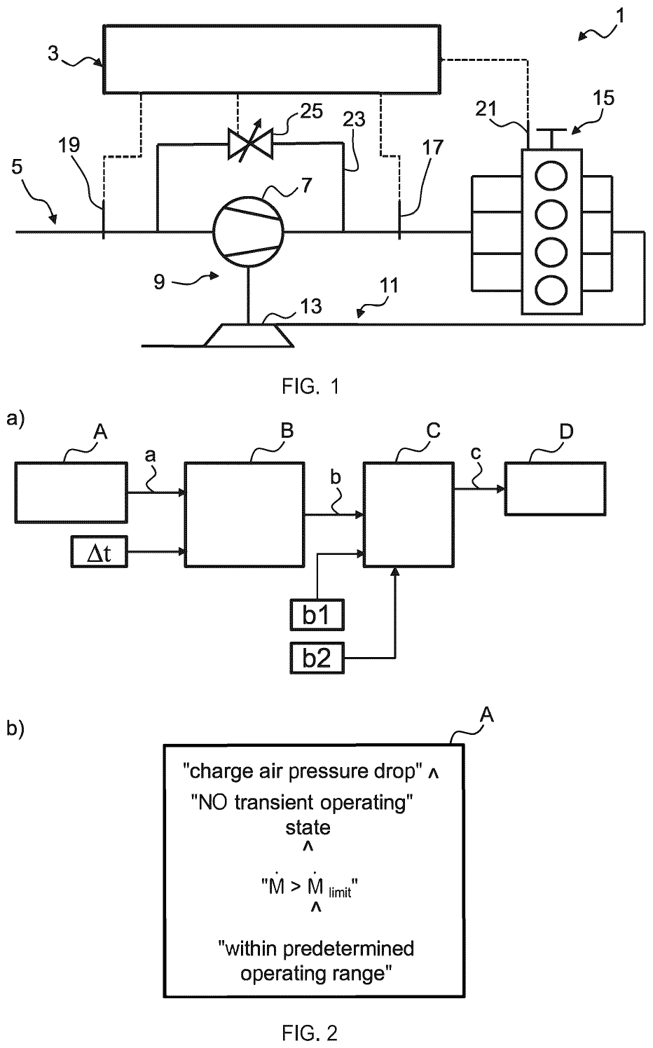

FIG. 2 shows a first schematic representation of an embodiment of the method for operating power generation device 1 according to FIG. 1.

Identical and functionally equivalent elements are provided with the same reference symbols in all figures, so that reference is made to the respective preceding description.

In particular, the charge air pressure downstream of charge air compressor 7 is detected by first charge air pressure sensor 17 and checked for a pressure drop, wherein at least one additional operating parameter of the power generation device that is correlated with the charge air pressure is detected, in particular by way of operating parameter sensor 21. The at least one additional operating parameter is evaluated in regard to plausibility of a surge event as the cause of a pressure drop in the charge air pressure; and a surge event of the charge air compressor 7 is identified if a drop in the detected charge air pressure is identified and, based on the evaluation of the at least one additional operating parameter, a surge event is assessed as being plausible as the cause of the pressure drop in the charge air pressure. This allows in particular to reliably identify compressor surging, so that a number of false-positive as well as false-negative results can at least be reduced, wherein incorrect assignments of events can optionally be completely avoided.

Under section a) in FIG. 2 an embodiment of the method is explained below,

referencing computing modules; the various computing modules do not necessarily have to be distinguishable from one another as separate hardware or software components. The illustration referencing the computing modules merely serves to explain the functionality of this embodiment of the method, without restricting generality. However, it is certainly conceivable that the method could be implemented, wherein the various computing modules are, for example, designed as separate software functions.

In first computing module A, a check is continuously conducted for a surge event of charge air compressor 7. First computing module A continuously issues—in particular at regular intervals—a first variable a, which indicates whether a surge event is currently identified, in particular in the current time cycle. For example, the variable a can have the value “0” if no surge event is identified, whereby variable a can assume value “1” if a surge event is identified.

In section b), the test for a surge event, which is conducted by first computing module A, is shown in more detail: In particular, computing module A verifies whether the following conditions are currently met, in particular in the current time cycle: a drop in the charge air pressure is detected, there is no transient operating state, a temporal torque gradient M of power generation device 1 is greater than a predetermined torque gradient limit value Mumit, and the operation of power generation device 1 is within a predetermined operating range. These conditions are all linked to one another in first computing module A by a logic AND, so that first computing module A only identifies a surge event, for example issues value “1” for variable a, if each of the listed conditions is met, wherein first computing module A does not identify a surge event and, for example, issues value “0” for variable a if at least one of the listed conditions is not met.

In particular, a pressure drop in the charge air pressure is identified when a second time derivative of the charge air pressure drops below a predetermined negative derivative limit value.

In particular, a key figure is determined that indicates how many surge events are identified within a predetermined time window.

In particular, returning to the illustration in a), the surge events are counted in second computing module B, wherein second computing module B issues the value of a counter b as a second variable and as the key figure, wherein counter b indicates the number of surge events detected. In particular, counter b is always incremented when variable a indicates the identification of a further surge event, in other words, when it changes, for example from value “0” to value “1”.

In one arrangement, it is possible after expiration of a predetermined time window Δt for counter b to be reset by second computing module B, in particular to be set to value “0”. In another arrangement, second computing module B assigns a time stamp to each individual surge events and decrements the value of counter b after predetermined time window Δt has expired, respectively calculated from the time stamp of each surge event. Thus, counter b indicates to some extent a sliding time average of surge events over predetermined time window Δt at any time.

In third computing module C, counter b is compared on the one hand with a predetermined first key figure limit value b1 and on the other hand with a predetermined second key figure limit value b2. Predetermined second key figure limit value b2 is in particular greater than predetermined first key figure limit value b1. Depending on the result of the comparison, third calculation module C issues a third variable c. This can, for example, assume value “0” if counter b is not greater than predetermined first key figure limit value b1, and it can assume value “1” if counter b is greater than predetermined first key figure limit value b1 but not greater than predetermined second key figure limit value b2, and it can assume value “2” if counter b is greater than predetermined second key figure limit value b2.

In fourth computing module D, various measures are initiated depending on the value of third variable c. In particular, at least a first measure is initiated when counter b exceeds predetermined first key figure limit value b1. Optionally, at least a second measure is initiated when counter b exceeds predetermined second key figure limit value b2. In particular, no measure is initiated if counter b does not exceed predetermined first key figure limit value b1.

The at least one first measure is optionally selected from a group consisting of a first alarm, a change in the flow cross-section of compressor bypass path 23, and a change in the flow cross-section of charge path 5.

The at least one second measure is optionally selected from a group consisting of a second alarm and shutdown of power generation device 1.

In particular, first computing module A, second computing module B, third computing module C and fourth computing module D do not operate sequentially but simultaneously, changing their respective internal states in particular subject to their respective computations, in particular subject to the respective input variables.

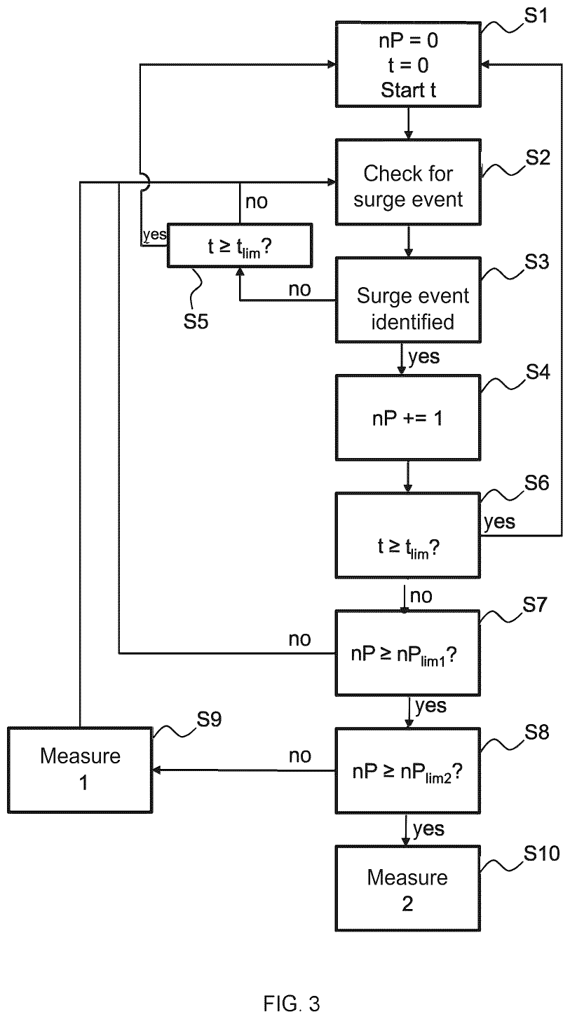

FIG. 3 shows a second schematic representation of an embodiment of the method.

In first step S1, a counter nP, which indicates the number of detected surge events as the key figure, is initialized with value zero. At the same time, time variable t is initialized with zero, and a time measurement with which time variable t is incremented is started.

In second step S2, a check is carried out for a surge event, in particular the same check being carried out as is also conducted in first computing module A, which is explained in connection with FIG. 2, in particular under section b). In second step S2, it is checked in particular, whether the following conditions are currently met, in particular in a current time cycle: a drop in the charge air pressure is detected; there is no transient operating state; a temporal torque gradient \dot{M} of power generation device 1 is greater than a predetermined torque gradient limit value \dot{M}ₗᵢₘᵢₜ; and the operation of power generation device 1 is in a predetermined operating range. These conditions are all linked to one another by a logic AND, so that a surge event is only identified if each of the conditions listed is met, wherein no surge event is identified if at least one of the conditions listed is not met.

In third step S3, the result of the check conducted in second step S2 is verified: If a surge event is identified, the method continues in fourth step S4; if, in contrast, no surge event is identified, fifth step S5 checks whether the current value of time variable t reaches or exceeds a predetermined time limit value tₗᵢₘ, where predetermined time limit value tₗᵢₘ corresponds in particular to the duration of predetermined time window Δt, calculated from time t=0. If the current value of time variable t reaches or exceeds predetermined time limit value tₗᵢₘ, the method returns to first step S1; otherwise, the process returns to second step S2 and the check for a surge event is conducted again.

In fourth step S4, counter nP is incremented. Subsequently, in sixth step S6, it is checked whether the current value of time variable t reaches or exceeds predetermined time limit value tₗᵢₘ. If this is the case, the process returns to first step S1, otherwise the process is continued in seventh step S7.

In seventh step S7, it is checked whether counter nP reaches or exceeds a predetermined first surge event limit value nPₗᵢₘ₁, wherein first predetermined surge event limit value nPₗᵢₘ₁ is in particular equal to first key figure limit value b1. If counter nP does not reach or exceed predetermined first surge event limit value nPₗᵢₘ₁, the process returns to second step S2 and the check for a surge event is carried out again. If, on the other hand, counter nP reaches or exceeds predetermined first surge event limit value nPₗᵢₘ₁, it is checked in eighth step S8 whether counter nP additionally reaches or exceeds a predetermined second surge event limit value nPₗᵢₘ₂, wherein the second predetermined surge event limit value nPₗᵢₘ₂ is in particular equal to second key figure limit value b2.

If the check in eighth step S8 shows that counter nP does not reach or exceed predetermined second surge event limit value nPₗᵢₘ₂, the at least one first measure is initiated in ninth step S9, after which the process returns to second step S2. If, on the other hand, the check in eighth step S8 shows that counter nP also reaches or exceeds predetermined second surge event limit value nPₗᵢₘ₂, the at least one second measure is initiated in tenth step S10, after which the process optionally ends, in particular if power generation device 1 is switched off due to the second measure.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a power generation device, the method comprising the steps of:
providing that the power generation device includes a charge air compressor;
detecting a charge air pressure downstream of the charge air compressor, and checking the charge air pressure downstream of the charge air compressor for a pressure drop;
detecting at least one additional operating parameter of the power generation device which is correlated with the charge air pressure;
evaluating the at least one additional operating parameter in regard to a plausibility of a surge event having caused the pressure drop in the charge air pressure; and
identifying the surge event of the charge air compressor if a drop in the charge air pressure—which is detected—is identified, and, based on the step of evaluating the at least one additional operating parameter, the surge event is evaluated to be plausible for having caused the pressure drop in the charge air pressure.

2. The method according to claim 1, wherein a key figure is determined which indicates how many of the surge event are identified within a predetermined time window, and wherein at least one first measure is initiated if the key figure—which is determined—exceeds a predetermined first key figure limit value.

3. The method according to claim 2, wherein at least one second measure is initiated when the key figure—which is determined—exceeds a predetermined second key figure limit value, wherein the predetermined second key figure limit value is greater than the predetermined first key figure limit value.

4. The method according to claim 1, wherein a check is conducted as to whether the power generating device is operated within a predetermined operating range, and wherein the surge event is only identified if the power generating device is operated within the predetermined operating range.

5. The method according to claim 1, wherein a check is conducted as to whether a transient operating state exists for the power generation device, wherein the surge event is only identified if no transient operating state exists for the power generation device.

6. The method according to claim 1, wherein a key figure is determined which indicates how many of the surge event are identified within a predetermined time window, wherein at least one first measure is initiated if the key figure—which is determined—exceeds a predetermined first key figure limit value, and wherein the at least one first measure is selected from a group consisting of: a first alarm; a change in a flow cross-section of a compressor bypass path around the charge air compressor; and a change in a flow cross-section of a charge path in which the charge air compressor is arranged.

7. The method according to claim 6, wherein at least one second measure is initiated when the key figure—which is determined—exceeds a predetermined second key figure limit value, wherein the predetermined second key figure limit value is greater than the predetermined first key figure limit value, and wherein the at least one second measure is selected from a group consisting of: a second alarm; and shutting down of the power generating device.

8. The method according to claim 1, wherein the power generation device includes an exhaust gas turbocharger which includes the charge air compressor, and wherein an operating parameter which is positively correlated with an exhaust gas mass flow of the power generation device is used as the at least one additional operating parameter.

9. The method according to claim 1, wherein a torque of the power generation device is detected as the at least one additional operating parameter.

10. The method according to claim 9, wherein the torque is checked in terms of whether the torque drops, and wherein the surge event is assessed as plausible as having caused the pressure drop in the charge air pressure if the torque is determined not to drop.

11. A control device for a power generation device, the control device comprising:
the control device, which is configured for carrying out a method for operating a power generation device, the method including the steps of:
providing that the power generation device includes a charge air compressor;
detecting a charge air pressure downstream of the charge air compressor, and checking the charge air pressure downstream of the charge air compressor for a pressure drop;
detecting at least one additional operating parameter of the power generation device which is correlated with the charge air pressure;
evaluating the at least one additional operating parameter in regard to a plausibility of a surge event having caused the pressure drop in the charge air pressure; and
identifying the surge event of the charge air compressor if a drop in the charge air pressure—which is detected—is identified, and, based on the step of evaluating the at least one additional operating parameter, the surge event is evaluated to be plausible for having caused the pressure drop in the charge air pressure.

12. A power generation device, comprising:
a charge path;
a charge air compressor arranged in the charge path;
a control device, which is configured for carrying out a method for operating the power generation device, the method including the steps of:
providing that the power generation device includes the charge air compressor;
detecting a charge air pressure downstream of the charge air compressor, and checking the charge air pressure downstream of the charge air compressor for a pressure drop;
detecting at least one additional operating parameter of the power generation device which is correlated with the charge air pressure;
evaluating the at least one additional operating parameter in regard to a plausibility of a surge event having caused the pressure drop in the charge air pressure; and
identifying the surge event of the charge air compressor if a drop in the charge air pressure—which is detected—is identified, and, based on the step of evaluating the at least one additional operating parameter, the surge event is evaluated to be plausible for having caused the pressure drop in the charge air pressure.

13. The power generation device according to claim 12, further including an exhaust path and a turbine arranged in the exhaust path, wherein the charge air compressor is drive-connected to the turbine.

14. The power generation device according to claim 12, wherein power generation device is configured as an internal combustion engine or as a fuel cell.
